(19) United States
(12) Patent Application Publication
(10) Pub. No.: US 2026/0068848 A1
(43) Pub. Date: Mar. 12, 2026

(54) Spreading Device and System

(71) Applicant: Bonsai Robotics Inc., San Jose, CA (US)

(72) Inventors: Claire Delaunay, Menlo Park, CA (US); Anthony D. Sandoval, Royal Oaks, CA (US)

(21) Appl. No.: 19/323,213

(22) Filed: Sep. 9, 2025

Related U.S. Application Data
(60) Provisional application No. 63/692,386, filed on Sep. 9, 2024.

(51) Int. Cl. A01K 1/08

(52) U.S. Cl. CPC A01K 1/08; A01K 2227/706

(57) ABSTRACT

Provided is a device including a container adapted to hold a granular material, a vibration motor connected to the container and configured to vibrate the container, a dispensing arrangement configured to dispense the granular material from the container while the container is vibrating, an attachment arrangement adapted to connect to a platform, and at least one dampener arranged between the container and the attachment arrangement, the at least one dampener adapted to dampen vibrations from the container.

### CROSS-REFERENCE TO RELATED APPLICATION

This application claims the benefit of U.S. Provisional Application No. 63/692,386, filed Sep. 9, 2024, the disclosure of which is hereby incorporated in its entirety.

### BACKGROUND

### 1. Field

This disclosure relates generally to spreading devices and systems.

### 2. Technical Considerations

Applying materials to crops in a field or greenhouse can be done manually or automatically. For spreading materials such as beneficial insects, existing systems are not equipped to evenly distribute the material mixture due to it separating before delivery.

### SUMMARY

According to non-limiting embodiments or aspects, provided is a device comprising: a container adapted to hold a granular material; a vibration motor connected to the container and configured to vibrate the container; a dispensing arrangement configured to dispense the granular material from the container while the container is vibrating; an attachment arrangement adapted to connect to a platform; and at least one dampener arranged between the container and the attachment arrangement, the at least one dampener adapted to dampen vibrations from the container.

In non-limiting embodiments or aspects, the dispensing arrangement comprises at least one metering drum configured to meter an amount of the granular material to be dispensed. In non-limiting embodiments or aspects, the container comprises: a center portion connected to the dispensing arrangement; a first side portion having a bottom angled downward toward the center portion; and a second side portion having a bottom angled downward toward the center portion. In non-limiting embodiments or aspects, the first side portion and the second side portion are at least partially conical. In non-limiting embodiments or aspects, the container is configured to rotate while being vibrated. In non-limiting embodiments or aspects, the granular material comprises a mixture of vermiculite and insects. In non-limiting embodiments or aspects, the attachment arrangement is adapted to connect to a platform of a vehicle. In non-limiting embodiments or aspects, the device further includes at least one processor configured to control the vibration motor and/or the dispensing arrangement. In non-limiting embodiments or aspects, the device further includes a network adapter, the at least one processor is configured to communicate with a remote system via the network adapter to control the vibration motor and/or the dispensing arrangement. In non-limiting embodiments or aspects, the device further includes at least one sensor configured to detect if the granular material is being dispensed by the dispensing arrangement.

According to non-limiting embodiments or aspects, provided is a system comprising: a vehicle assembly; a container adapted to hold a granular material; a vibration motor connected to the container and configured to vibrate the container; a dispensing arrangement configured to dispense the granular material from the container while the container is vibrating; and an attachment arrangement adapted to attach the container to the vehicle assembly.

In non-limiting embodiments or aspects, the system includes at least one dampener arranged between the container and the vehicle assembly, the at least one dampener adapted to dampen vibrations from the container. In non-limiting embodiments or aspects, the dispensing arrangement comprises at least one metering drum configured to meter an amount of the granular material to be dispensed. In non-limiting embodiments or aspects, the container comprises: a center portion connected to the dispensing arrangement; a first side portion having a bottom angled downward toward the center portion; and a second side portion having a bottom angled downward toward the center portion. In non-limiting embodiments or aspects, the first side portion and the second side portion are at least partially conical. In non-limiting embodiments or aspects, the container is configured to rotate while being vibrated. In non-limiting embodiments or aspects, the granular material comprises a mixture of vermiculite and insects. In non-limiting embodiments or aspects, the system includes at least one processor configured to control the vibration motor and/or the dispensing arrangement. In non-limiting embodiments or aspects, the system includes a network adapter, the at least one processor is configured to communicate with a remote system via the network adapter to control the vibration motor and/or the dispensing arrangement. In non-limiting embodiments or aspects, the system includes: at least one additional container adapted to hold additional granular material; and at least one additional dispensing arrangement configured to dispense the additional granular material from the container while the at least one additional container is vibrating. In non-limiting embodiments or aspects, the granular material comprises a first type of insect and the additional granular material comprises a second type of insect different than the first type of insect.

Further non-limiting embodiments or aspects are set forth in the following numbered clauses.
Clause 1: A device comprising: a container adapted to hold a granular material; a vibration motor connected to the container and configured to vibrate the container; a dispensing arrangement configured to dispense the granular material from the container while the container is vibrating; an attachment arrangement adapted to connect to a platform; and at least one dampener arranged between the container and the attachment arrangement, the at least one dampener adapted to dampen vibrations from the container.
Clause 2: The device of clause 1, wherein the dispensing arrangement comprises at least one metering drum configured to meter an amount of the granular material to be dispensed.
Clause 3: The device of any of clauses 1-2, wherein the container comprises: a center portion connected to the dispensing arrangement; a first side portion having a bottom angled downward toward the center portion; and a second side portion having a bottom angled downward toward the center portion.
Clause 4: The device of any of clauses 1-3, wherein the first side portion and the second side portion are at least partially conical.
Clause 5: The device of any of clauses 1-4, wherein the container is configured to rotate while being vibrated.
Clause 6: The device of any of clauses 1-5, wherein the granular material comprises a mixture of vermiculite and insects.
Clause 7: The device of any of clauses 1-6, wherein the attachment arrangement is adapted to connect to a platform of a vehicle.
Clause 8: The device of any of clauses 1-7, further comprising at least one processor configured to control the vibration motor and/or the dispensing arrangement.
Clause 9: The device of any of clauses 1-8, further comprising a network adapter, wherein the at least one processor is configured to communicate with a remote system via the network adapter to control the vibration motor and/or the dispensing arrangement.
Clause 10: The device of any of clauses 1-9, further comprising at least one sensor configured to detect if the granular material is being dispensed by the dispensing arrangement.
Clause 11: A system comprising: a vehicle assembly; a container adapted to hold a granular material; a vibration motor connected to the container and configured to vibrate the container; a dispensing arrangement configured to dispense the granular material from the container while the container is vibrating; and an attachment arrangement adapted to attach the container to the vehicle assembly.
Clause 12: The system of clause 11, further comprising at least one dampener arranged between the container and the vehicle assembly, the at least one dampener adapted to dampen vibrations from the container.
Clause 13: The system of any of clauses 11-12, wherein the dispensing arrangement comprises at least one metering drum configured to meter an amount of the granular material to be dispensed.
Clause 14: The system of any of clauses 11-13, wherein the container comprises: a center portion connected to the dispensing arrangement; a first side portion having a bottom angled downward toward the center portion; and a second side portion having a bottom angled downward toward the center portion.
Clause 15: The system of any of clauses 11-14, wherein the first side portion and the second side portion are at least partially conical.
Clause 16: The system of any of clauses 11-15, wherein the container is configured to rotate while being vibrated.
Clause 17: The system of any of clauses 11-16, wherein the granular material comprises a mixture of vermiculite and insects.
Clause 18: The system of any of clauses 11-17, further comprising at least one processor configured to control the vibration motor and/or the dispensing arrangement.
Clause 19: The system of any of clauses 11-18, further comprising a network adapter, wherein the at least one processor is configured to communicate with a remote system via the network adapter to control the vibration motor and/or the dispensing arrangement.
Clause 20: The system of any of clauses 11-19, further comprising: at least one additional container adapted to hold additional granular material; and at least one additional dispensing arrangement configured to dispense the additional granular material from the container while the at least one additional container is vibrating.
Clause 21: The system of any of clauses 11-20, wherein the granular material comprises a first type of insect and the additional granular material comprises a second type of insect different than the first type of insect.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1A is a front view of a spreading device according to non-limiting embodiments;

FIG. 1B is a front view of a spreading device according to non-limiting embodiments;

FIG. 1C is a perspective view of a spreading device according to non-limiting embodiments;

FIG. 2A is a front view of a spreading device with cross-sectional detail according to non-limiting embodiments;

FIG. 2B is a side view of a spreading device with cross-sectional detail according to non-limiting embodiments;

FIG. 3A is a top view of a vehicle assembly with multiple spreading devices according to non-limiting embodiments;

FIG. 3B is a perspective view of a vehicle assembly with multiple spreading devices according to non-limiting embodiments;

FIG. 3C is a front view of a vehicle assembly with multiple spreading devices according to non-limiting embodiments;

FIG. 3D is a side view of a vehicle assembly with multiple spreading devices according to non-limiting embodiments;

FIG. 4A is a schematic diagram of a spreading device system according to non-limiting embodiments;

FIG. 4B is another schematic diagram of a spreading device system according to non-limiting embodiments; and

FIG. 5 is a schematic diagram of example computing components used in non-limiting embodiments.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “computing device” may refer to one or more electronic devices configured to process data. A controller may include, for example, any type of data processor (e.g., a microprocessor, Central Processing Unit (CPU), Graphics Processing Unit (GPU), and/or the like) and/or controller. A computing device may be a microcontroller in the form of one or more integrated circuits (IC). A computing device may be dedicated for a particular purpose (e.g., controlling a motor) or may be multi-purpose and perform several different functions. A computing device may also include one or more additional components, such as memory, a display, an input device, a network interface, and/or the like. A computing device may include, for example, one or more mobile devices (e.g., smartphones, wearable devices, and/or the like), personal computers, server computers, and/or the like.

Multiple computing devices (e.g., servers, mobile devices, etc.) directly or indirectly communicating in a networked arrangement may constitute a “system.” Reference to “a computing device” or “a processor,” as used herein, may refer to a previously-recited computing device that is recited as performing a previous step or function, a different controller, and/or a combination of computing devices. For example, as used in the specification and the claims, a first “computing device” or “processor” that is recited as performing a first step or function may refer to the same or different “computing device”or “processor”recited as performing a second step or function.

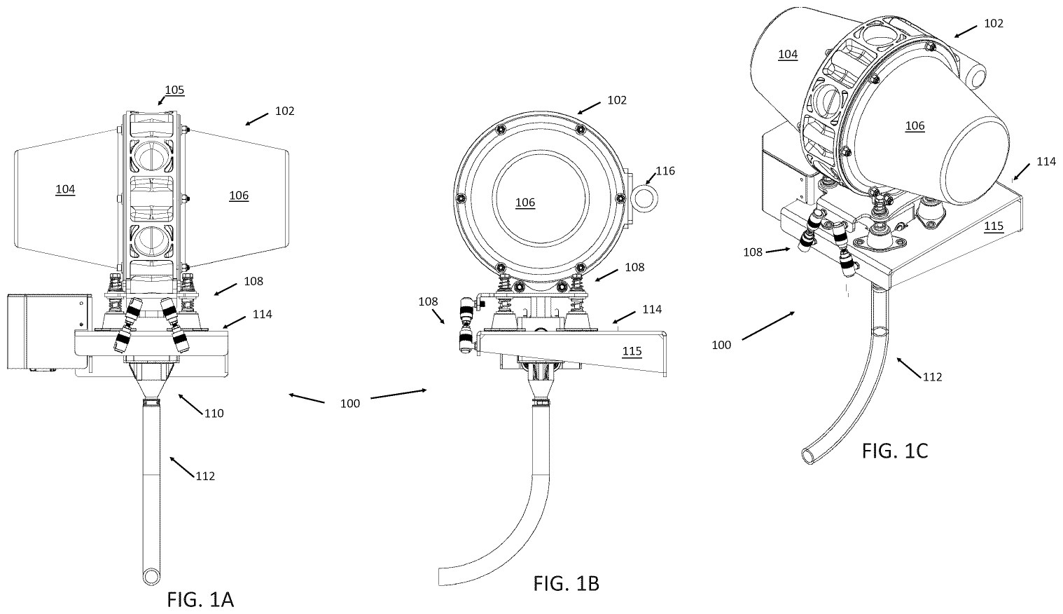

Referring now to FIGS. 1A, 1B, and 1C, a spreading device 100 is shown according to non-limiting embodiments. FIG. 1A shows a spreading device 100 from a front view, FIG. 1B shows a spreading device 100 from a side view, and FIG. 1C shows a spreading device 100 from a perspective view.

In non-limiting embodiments, the spreading device may include a container 102 adapted to hold a granular material, such as but not limited to beneficial insects, fertilizer, seed, or any other type of granular material that is desired to be spread over an area. In non-limiting embodiments, the granular material may include dry vermiculite mixed with insects. The container 102 may include a first side portion 104, a second side portion 106, and a center portion 105 that connects to the first side portion 104 and second side portion 106. The first and second side portions may have a bottom that is angled downward toward the center portion 105 such that material in the first or second side portions slides down to the center of the device 100. In some examples, the first and second side portions may be conical.

In non-limiting embodiments, the spreading device 100 also includes a vibration motor 116 connected to the container and configured to vibrate the container 102. The vibration motor 116 may include, for example, any motor and/or motorized device configured to cause movement of the container 102. As an example, a motor may be attached to the container so that vibration from the motor housing is transferred to the container 102. The vibration motor 116 may be attached to the container 102. For example, the vibration motor 116 may be attached to the first side portion 104, center portion 105, and/or second side portion 106. The vibration motor 116 may be in electrical communication with a power source, such as a battery. The power source may be part of the spreading device 100 or may be part of another system that the spreading device 100 is attached to, such as a robot and/or a vehicle.

Additionally, or alternatively, a piston or other like device attached to the motor may be arranged to vibrate the container 102 by repeatedly making contact. It will be appreciated that other arrangements are possible to cause vibration of the container 102. In non-limiting embodiments, the amount of vibration may be adjusted by adjusting a speed of the motor and/or placement of the motor. The container 102 may be vibrated to keep the granular material mixed and/or to prevent clumping. For example, in a mix of vermiculate and insects, without vibration the insects will separate from the vermiculate and move to the top of the mixture inside the container 102.

In non-limiting embodiments, the spreading device 100 may include a dispensing arrangement 110 configured to dispense the granular material from the container 102 while the container 102 is vibrating. The dispensing arrangement 110 may include a funnel attached to a bottom or side of the container 102 to receive granular material that is received through one or more openings and to direct the granular material to the target region via a hose 112, chute, or another like device. In non-limiting embodiments, the dispensing arrangement 110 may include one or more sensors configured to detect if material is being dispensed. For example, an optical sensor may be arranged at an outlet of the metering drum, inlet of a hose 112, and/or the like. The optical sensor may return a signal that can be used by a processor to determine if material is being dispensed. For example, if material is clogged or depleted, the sensor may detect a lack of material and cause an alert to be displayed or audibly played to an operator on the spreading device 100 and/or on a remote computing device.

In non-limiting embodiments, the spreading device 100 may include an attachment arrangement 114 adapted to connect to a platform 115, such as a platform of a vehicle or robot. The attachment arrangement 114 may include and/or may be in contact with one or more dampeners 108 arranged between the container 102 and the platform 115 to dampen vibrations and reduce the amount of vibration transferred to the platform 115 and/or vehicle or robot. The dampeners 108 may include any material or mechanism adapted to dampen vibrations. For example, the dampeners 108 may include one or more springs, pieces of rubber, shocks, pneumatic compressors, and/or the like.

In non-limiting embodiments, the spreading device 100 may include one or more computing devices, such as a controller, processor (e.g., microprocessor, CPU, etc.), and/or the like. The one or more computing devices may communicate with a remote system, such as a user computing device and/or robotic control system, over a network through one or more network adapters. In some examples, a user interface may be provided on the spreading device 100 itself. The one or more computing devices may also be used to configure the vibration motor 116, dispensing arrangement 110, and/or other operational parameters of the spreading device 100. For example, a frequency of the vibration motor 116 may be configured by a computing device. Different frequencies may therefore be used for different types of material. The frequency may also be adjusted to resonate with the dampeners and/or other components of the spreading device 100. In non-limiting embodiments, the dispensing arrangement 110 may also be configured to control an amount of material being distributed by, for example, controlling the speed of a metering drum and/or an amount of vibration. Such adjustments may be made directly to the spreading device 100 through one or more user interfaces of the computing device and/or through a remote computing device in communication with a computing device on the spreading device 100. A remote computing device may display a graphical user interface (GUI) with tools to adjust one or more operational parameters, such as the amount of material to be distributed.

In non-limiting embodiments, different spreading devices 100 on a vehicle may be separately configured to have different vibrations and/or metering drum rotation speeds. This allows for different granular materials to be used, such that different types of beneficial insects or other materials may be applied to different crops and/or different rows of crops. In this way, the vibration frequency may be adjusted for each spreading device 100 based on the material being spread by that device, where some insects may need more vibration and ongoing mixing than other insects and/or other materials.

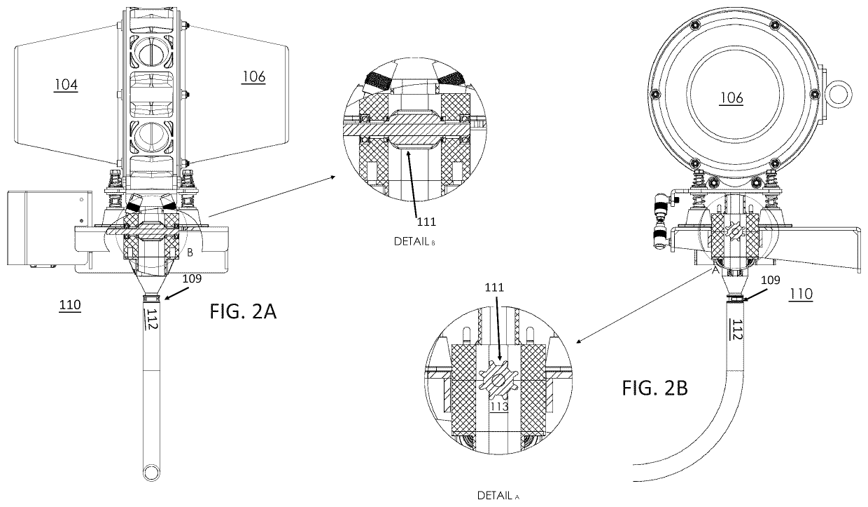

Referring now to FIGS. 2A and 2B, the spreading device 100 shown in FIG. 1 is shown with a detailed cross-sectional view according to non-limiting embodiments. FIG. 2B shows a front view of a dispensing arrangement 110 that includes a metering drum 111. FIG. 2A shows a side view of the metering drum 111, which is shown as a hub and spoke drum that rotates to carry granular material from the container to the hose 112. In operation, the granular material falls from the container being vibrated to a top side of the metering drum 111, where the granular material is carried in the recesses between two adjacent spokes that rotate until the granular material falls from a bottom side 113 of the metering drum 111, such that it is carried by the hose 112 to its target destination. In this manner, the rotational speed of the metering drum 111 may be adjusted to adjust the amount of material being dispersed, such that a slower rotational speed results in less material being distributed.

It will be appreciated that other arrangements of a metering drum 111 may be used, such as a drum with other forms of recesses to carry the granular material. In some examples, a different metering device may be used, such as an aperture that repeatedly opens and closes and/or the like. In non-limiting embodiments, the metering drum 111 includes a drum within a drum, such that the interior drum includes the spokes and the exterior drum contains the material. In non-limiting embodiments, the metering drum 111 provides metering of the material without pinch points to avoid affecting the material (e.g., minimizing damage to insects being dispersed).

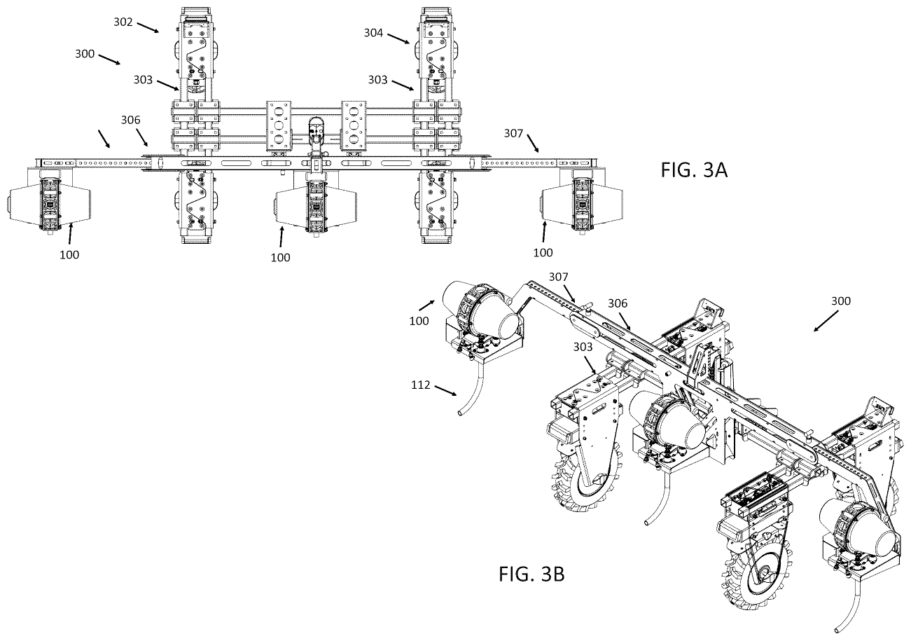

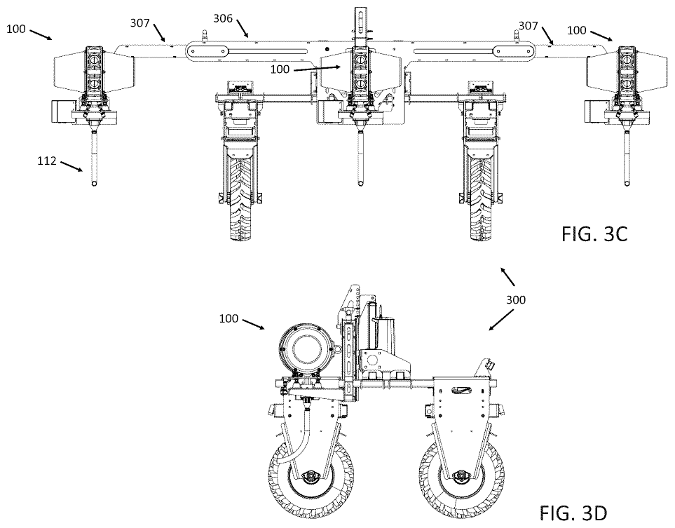

Referring now to FIGS. 3A-3D, shown is a vehicle assembly 300 with multiple spreading devices 100 mounted thereon according to non-limiting embodiments. FIG. 3A is a top view of a vehicle assembly 300 with multiple spreading devices, FIG. 3B is a perspective view, FIG. 3C is a front view, and FIG. 3D is a side view. It will be appreciated that any number of spreading devices may be arranged on a vehicle assembly 300. The vehicle assembly 300 may be for a robotic device and/or a human-operated vehicle.

The vehicle assembly 300 may include one or more wheel assemblies 302, 304 and one or more longitudinal support members 306. In non-limiting embodiments, the vehicle assembly may include the modular vehicle and wheel assembly shown and described in U.S. patent application Ser. No. 18/588,858 (US Pub. No. 2024-0199152-A1), the disclosure of which is hereby incorporated by reference in its entirety. The vehicle assembly 300 may also include one or more lateral support members 303 for supporting the wheel assemblies and for connecting the longitudinal support member 306. By adjusting the lateral support member(s) 303 and the longitudinal support member(s) 306, various sizes can be achieved for different environments, types of crops, and/or the like.

In non-limiting embodiments, the longitudinal support members 306 may be adjustable to change the position of the spreading devices 100. In this manner, the location of the spreading devices 100 can be adjusted based on the width of the crop row and/or other like considerations. The longitudinal support members may be adjusted manually or automatically and may be configurable with a computing device. In the example shown in FIGS. 3A-3D, the longitudinal support member 306 receives two or more supports that slide with respect to each other. For example, a fixed longitudinal support 306 may be attached to the vehicle assembly and may receive, at each end, a slidable longitudinal support 307 that can be locked into position with one or more pins and/or other attachment devices.

Any number of spreading devices 100 may be arranged on a vehicle in non-limiting embodiments. In the example shown in FIGS. 3A-3D, three spreading devices 100 may be used to spread material over three adjacent rows of crops at once, with the wheel assemblies straddling a middle row of crops and the support member 306 extending over the two adjacent rows of crops. In non-limiting embodiments, the spreading devices 100 may have different distribution rates, different materials (e.g., different types of insects to different crops), and/or the like, based on the different crops in each row and/or other considerations. In non-limiting embodiments, operational parameters, such as the distribution rates, may be adjusted automatically based on data representing the crops and/or spatial layout in which the vehicle assembly 300 operates.

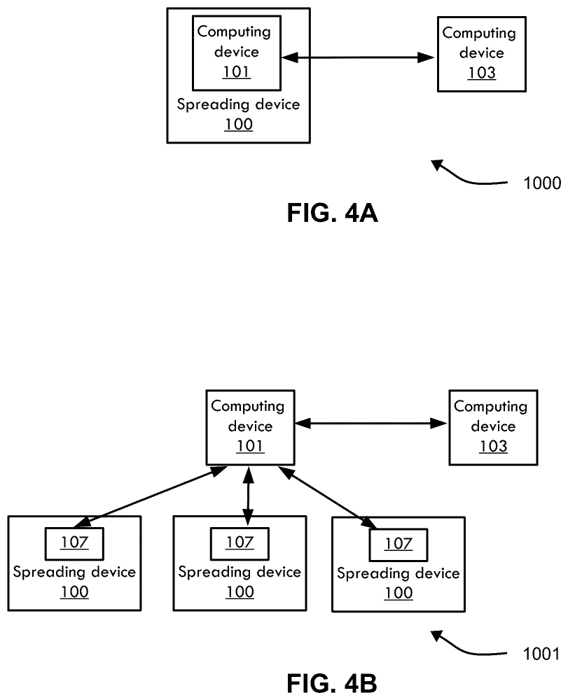

Referring now to FIGS. 4A and 4B, a spreading device system 1000, 1001 is shown according to non-limiting embodiments. In FIG. 4A, the spreading device system 1000 includes a spreading device having a computing device 101 in communication with a remote computing device 103 via a network environment. The computing device 101 may be used to monitor dispensing (e.g., through communication with a sensor), control vibration, control meter drum rotation, and/or the like. In FIG. 4B, the spreading device system 1000 includes multiple spreading devices each having a computing device 107 in communication with a primary computing device 101 associated with the vehicle assembly (e.g., such as an on-board computing device). The on-board computing device 101 may control the individual spreading devices 100 through communication with the computing devices 107 of each and may be remotely controlled by remote computing device 103 via a network environment. It will be appreciated that other arrangements are possible.

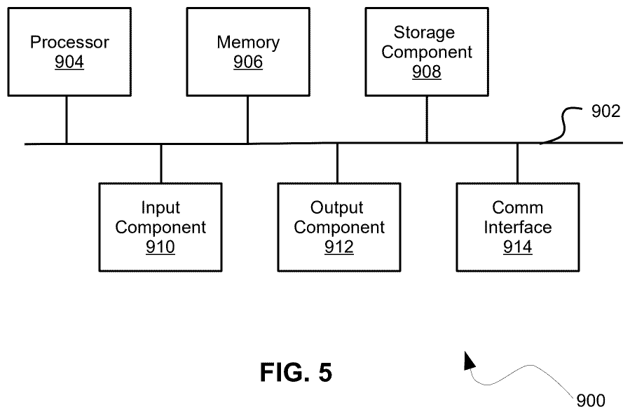

Referring now to FIG. 5, shown is a diagram of example components of a computing device for implementing and performing the systems described herein according to non-limiting embodiments. In some non-limiting embodiments, device 900 may include additional components, fewer components, different components, or differently arranged components than those shown in FIG. 5. Device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 5, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a photo-sensor, a thermal sensor, an electromagnetic field sensor, a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although the disclosed subject matter has been described in detail for the purpose of illustration based on what is currently considered to be the most practical and preferred embodiments or aspects, it is to be understood that such detail is solely for that purpose and that the disclosed subject matter is not limited to the disclosed embodiments or aspects, but, on the contrary, is intended to cover modifications and equivalent arrangements that are within the spirit and scope of the appended claims. For example, it is to be understood that the presently disclosed subject matter contemplates that, to the extent possible, one or more features of any embodiment or aspect can be combined with one or more features of any other embodiment or aspect.

What is claimed is

1. A device comprising:
a container adapted to hold a granular material;
a vibration motor connected to the container and configured to vibrate the container;
a dispensing arrangement configured to dispense the granular material from the container while the container is vibrating;
an attachment arrangement adapted to connect to a platform; and
at least one dampener arranged between the container and the attachment arrangement, the at least one dampener adapted to dampen vibrations from the container.

2. The device of claim 1, wherein the dispensing arrangement comprises at least one metering drum configured to meter an amount of the granular material to be dispensed.

3. The device of claim 1, wherein the container comprises:
a center portion connected to the dispensing arrangement;
a first side portion having a bottom angled downward toward the center portion; and
a second side portion having a bottom angled downward toward the center portion.

4. The device of claim 3, wherein the first side portion and the second side portion are at least partially conical.

5. The device of claim 1, wherein the container is configured to rotate while being vibrated.

6. The device of claim 1, wherein the granular material comprises a mixture of vermiculite and insects.

7. The device of claim 1, wherein the attachment arrangement is adapted to connect to a platform of a vehicle.

8. The device of claim 1, further comprising at least one processor configured to control the vibration motor and/or the dispensing arrangement.

9. The device of claim 8, further comprising a network adapter, wherein the at least one processor is configured to communicate with a remote system via the network adapter to control the vibration motor and/or the dispensing arrangement.

10. The device of claim 1, further comprising at least one sensor configured to detect if the granular material is being dispensed by the dispensing arrangement.

11. A system comprising:
a vehicle assembly;
a container adapted to hold a granular material;
a vibration motor connected to the container and configured to vibrate the container;
a dispensing arrangement configured to dispense the granular material from the container while the container is vibrating; and
an attachment arrangement adapted to attach the container to the vehicle assembly.

12. The system of claim 11, further comprising at least one dampener arranged between the container and the vehicle assembly, the at least one dampener adapted to dampen vibrations from the container.

13. The system of claim 11, wherein the dispensing arrangement comprises at least one metering drum configured to meter an amount of the granular material to be dispensed.

14. The system of claim 11, wherein the container comprises:
a center portion connected to the dispensing arrangement;
a first side portion having a bottom angled downward toward the center portion; and
a second side portion having a bottom angled downward toward the center portion.

15. The system of claim 14, wherein the first side portion and the second side portion are at least partially conical.

16. The system of claim 11, wherein the container is configured to rotate while being vibrated.

17. The system of claim 11, wherein the granular material comprises a mixture of vermiculite and insects.

18. The system of claim 11, further comprising at least one processor configured to control the vibration motor and/or the dispensing arrangement.

19. The system of claim 18, further comprising a network adapter, wherein the at least one processor is configured to communicate with a remote system via the network adapter to control the vibration motor and/or the dispensing arrangement.

20. The system of claim 11, further comprising:
at least one additional container adapted to hold additional granular material; and
at least one additional dispensing arrangement configured to dispense the additional granular material from the container while the at least one additional container is vibrating.

21. The system of claim 20, wherein the granular material comprises a first type of insect and the additional granular material comprises a second type of insect different than the first type of insect.
